(19) United States
(12) Patent Application Publication
(10) Pub. No.: US 2018/0017177 A1
(43) Pub. Date: Jan. 18, 2018

(54) INFLATABLE CUSHIONING DEVICE

(71) Applicant: Cascade Designs, Inc., Seattle, WA (US)

(72) Inventors: James Edward Marson, Seattle, WA (US); Douglas S. Jacot, Kingston, WA (US)

(21) Appl. No.: 15/553,137

(22) PCT Filed: Mar. 3, 2016
(86) PCT No.: PCT/US16/20775

§ 371 Date: Aug. 23, 2017

Related U.S. Application Data
(60) Provisional application No. 62/127,696, filed on Mar. 3, 2015.

(51) Int. Cl. F16K 15/20; A47C 27/08

(52) U.S. Cl. CPC F16K 15/202; A47C 27/081; F16K 15/207

(57) ABSTRACT

AH inflatable cushioning device includes an inflatable main body, a neck portion coupled to the main body, and a valve member having terminal and distal ends. The terminal end is coupled to the neck portion. The valve member has an inflation configuration in which the valve member distal end is disposed inside of the neck portion. The valve member has a deflation configuration in which the valve member distal end is disposed outside of the neck portion.

### PRIORITY CLAIM

This patent application claims priority to U.S. Provisional Patent Application Ser. No. 62/127,696 filed Mar. 3, 2015, the entirety of which is hereby incorporated by reference as if fully set forth herein.

### BACKGROUND

Conventional air mattresses are typically constructed of lightweight film, fabric or scrim-like cores that are highly compressible when packed, but require inflation either by mouth or with a variety of pumps. Some conventional air mattresses are open-cell foam filled and are fully or somewhat self-inflating, but are bulky when packed and heavier in weight than non-self-inflating air mattresses. Many conventional air mattresses have small valves and limited volumetric efficiency.

### DESCRIPTION OF THE DRAWINGS

Many of the attendant advantages of this invention will become more readily appreciated as the same become better understood by reference to the following detailed description when taken in conjunction with the accompanying drawings, wherein:

FIGS. 1-4 illustrate top plan views of a first embodiment of the invention;

FIG. 5 illustrates a top plan view of a second embodiment of the invention;

FIG. 6 illustrates a side cross-sectional view of the embodiment illustrated in FIG. 5;

FIG. 7 illustrates a top plan view of a third embodiment of the invention;

FIG. 8 is illustrates a side cross-sectional view of the embodiment illustrated in FIG. 7: and

FIGS. 9-10 illustrate a matrix core according to an embodiment of the invention.

### DETAILED DESCRIPTION

This patent application is intended to describe one or more embodiments of the present invention. It is to be understood that the use of absolute terms, such as “must,” “will,” and the like, as well as specific quantities, is to be construed as being applicable to one or more of such embodiments, but not necessarily to all such embodiments. As such, embodiments of the invention may omit, or include a modification of, one or more features or functionalities described in the context of such absolute terms.

An embodiment includes a unique air inflator and deflator for air mattresses. It is faster and easier to use than conventional designs. One or more embodiments include a simplified and automatically reversing duckbill valve for inflation and deflation for simplified operation and a less-complex roll down and buckled or plastic-zipper type closure. A plastic-zipper type closure may be bonded into the neck portion. The plastic-zipper type closure may include tabs to assist in opening it and a clip or slider to assist in closing it.

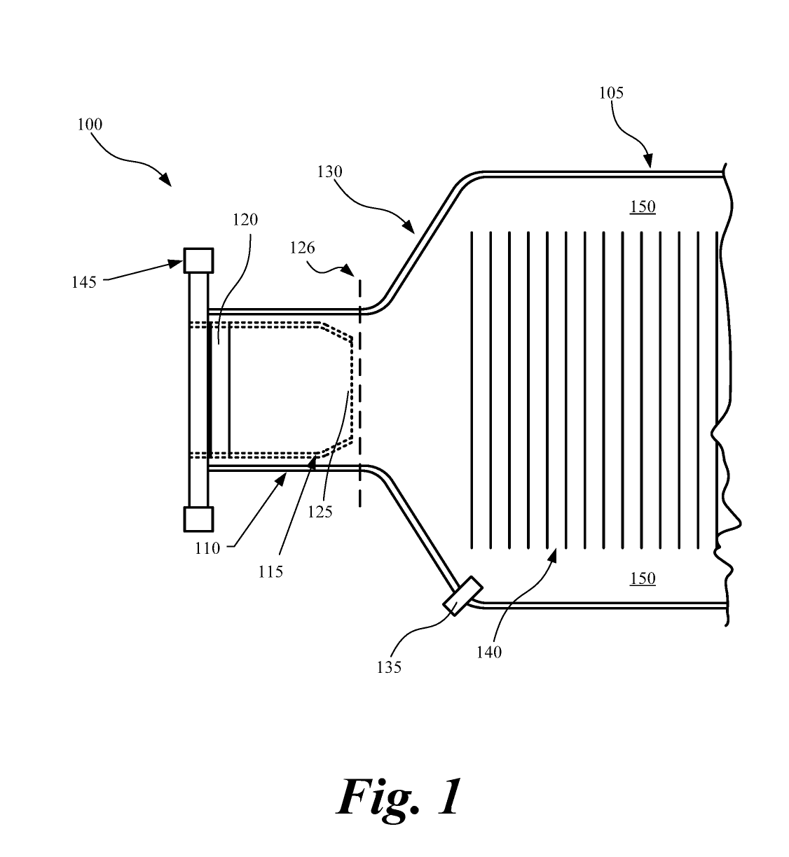

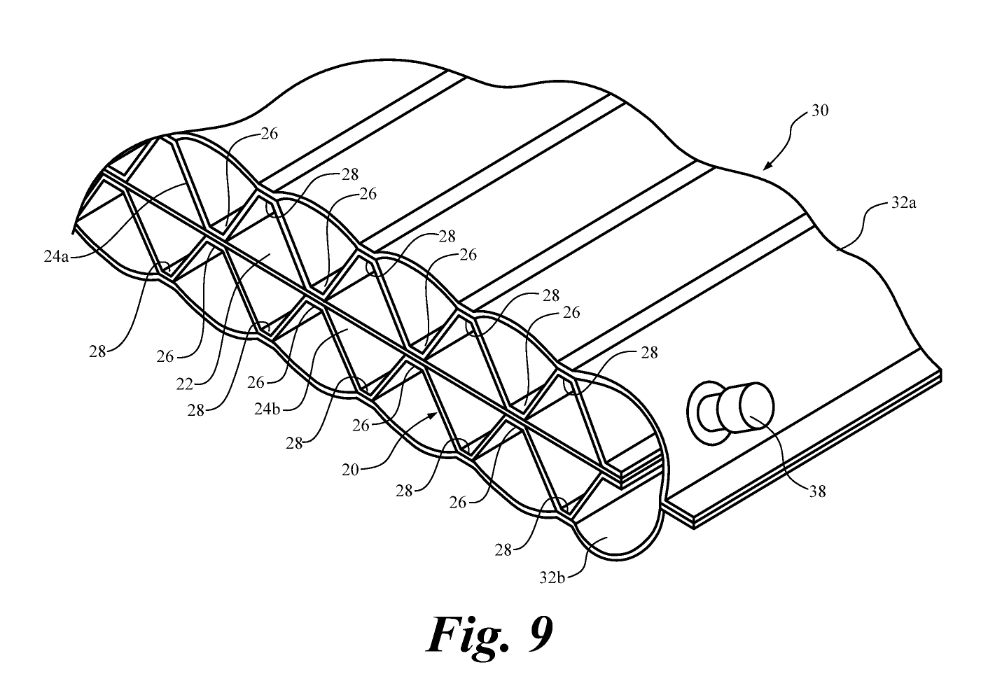

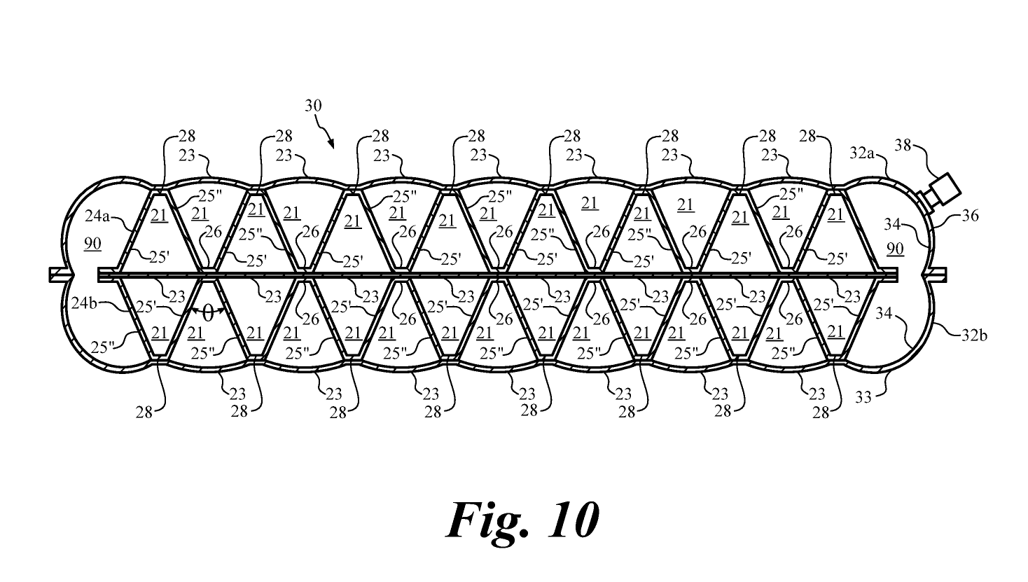

Referring to FIGS. 1-4, an inflatable cushioning device 100 according to an embodiment is illustrated. Device 100 includes an inflatable main body 105 in which is disposed a core 140 and side channels 150. Main body 105 and core 140 may be configured identical or similar to the configuration illustrated in and described with reference to FIGS. 9-10 and described in U.S. patent application Ser. No. 12/842,027 titled “CELLULAR MATRIX WITH INTEGRATED RADIANT AND AND/OR CONVECTION BARRIERS PARTICULARLY FOR USE WITH THE INFLATABLE BODIES,” which is hereby incorporated by reference in its entirety as if fully set forth herein.

More specifically, and referring to FIGS. 9-10, a general configuration of a matrix core 20 is shown in conjunction with inflatable body 30. Core 20, which in this embodiment is comprised only of thin urethane films in the form of film sheets, includes planar sheet 22 to which is bonded first corrugating or serpentine sheet 24a and second corrugating or serpentine sheet 24b (collectively or generally referred to as corrugating or serpentine sheet(s) 24). Each corrugating or serpentine sheet 24 comprises proximal apexes 26 and distal apexes 28, which are preferably heat or RF bonded to the adjacent material; the material between the two apexes constituting one side of two adjacent cells 21. In this illustrated embodiment, proximal apexes 26 of corrugating or serpentine sheets 24a and 24b are bonded to planar sheet 22 in general opposition to each other such that tension stress induced in sheet 24a, for example, transfers nearly directly to sheet 24b, and vice versa. This effective transference of tension forces beneficially provides the necessary tensile elements in certain article embodiments of the invention, and permits the use of relatively low tensile strength substitute materials in planar sheet 22.

Matrix core 20 is shown disposed in, and partially bonded to, inflatable body 30. Inflatable body 30 comprises first and second panels 32a and 32b, each having inner and outer surfaces 34 and 36 respectively, and which are joined at their opposing perimeters to form an enveloping structure, and which form cell walls for roughly half of the cells that comprise core 20 through the bonding of distal apexes 28 of corrugating or serpentine sheets 24 there to. To permit gas/air influx and efflux into and from the chamber defined by first and second panels 32a and 32b, valve 38 is disposed in one of the panels (here shown disposed in panel 32a). Presuming that the ends of cells 21 are not sealed and/or at least one wall in each cell is fluid/gas permeable, any fluid/gas within the chamber defined by first and second panels 32a and 32b will pass through valve 38 upon complete compression of body 30.

Each cell 21 in core 20 defines a longitudinal direction coincident with the cell axis or geometric “height” of the prism, and comprises tot purposes of identification two leg walls and a base wall. For convention and with reference to FIG. 10, any given cell 21 comprises base wall 23 and leg walls 25′, 25″ (note that the leg walls are visually discrete but are formed from a single instance of corrugating or serpentine sheet 24a or 24b). Leg walls 25′ and 25″ form an angle .theta. there between, the value of which is proportional to the lateral length of base wall 23. As will be discussed in more detail below, the value of .theta. is a factor in core 20's restorative bias as well as the load capacity of inflatable body 30.

Inflatable body embodiments of the invention need not only provide for a single chamber in which a core is disposed. With core 20 being longitudinally oriented and having planar sheet 22 essentially parallel to panels 32a and 32b as shown in FIG. 10, outward extension thereof to be included in the perimeter bond between panels 32a and 32b bifurcates the chamber. While not necessary, inclusion of one or both corrugating or serpentine sheets 24a and 24b in the peripheral bond may be desired. Alternatively, chamber bifurcation can be achieved if only one or both corrugating or serpentine sheets 24a and 24b extend into the peripheral portion of panels 32a and 32b. Side channels 150 may be configured similar to side channels 90 illustrated in. FIG. 10. Side channels 150 may serve as air-distribution manifolds and may have a total cross-sectional area 15-20% of the core 140 cross-sectional area. All or part of core 140 may be air permeable in an embodiment.

Referring again to FIGS. 1-4, device 100 further includes a neck portion 110 coupled to the main body 105 and configured to permit air flow between the main body and the ambient environment external to the device. Device 100 further includes a shoulder portion 130 serving as a transition zone between the main body 105 and the neck portion 110. As can be seen in FIGS. 1-4, the orientations of the neck portion 110 and main body 105 are substantially parallel to one another, while the shoulder portion 130 is oriented at an angle (e.g., ˜45 degrees) with respect to the neck portion and main body.

A valve member 115 includes a terminal end 120 and a distal end 125, the terminal end being attached to the neck portion 110. In an embodiment, the width of the valve member 115 is tapered from the terminal end 120 to the distal end 125, and is seamed along its edges, such that the distal end is less wide than the terminal end, thereby promoting automatic (i.e., not manual) closing of the valve member once the device 100 is fully or near-fully inflated.

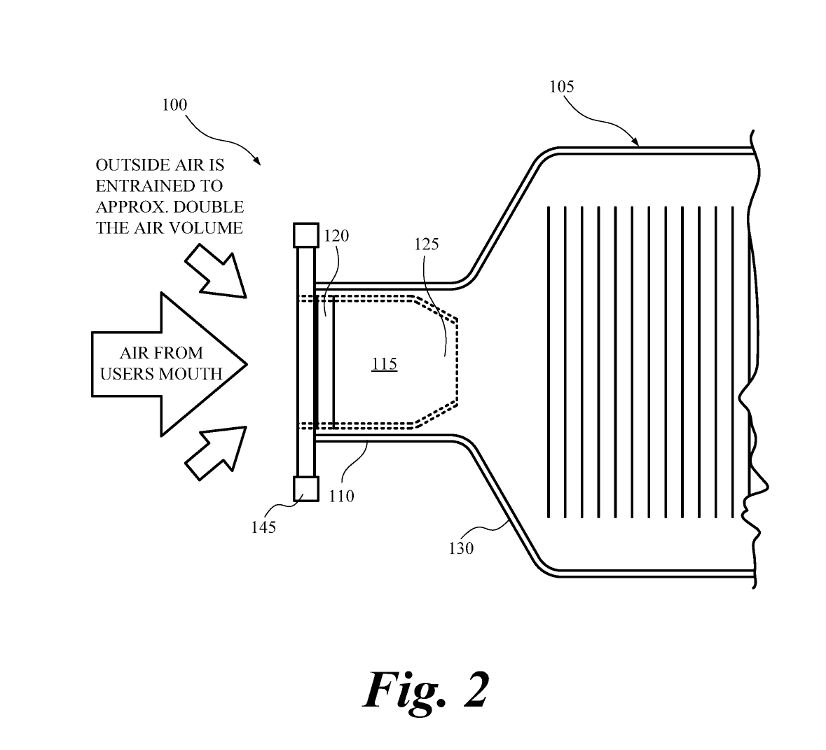

As best illustrated in FIGS. 1-2, the valve member 115 has an inflation configuration in which the valve member distal end 125 is disposed inside of the neck portion 110. As shown in FIG. 1, and in an embodiment, when the valve member 115 is in the inflation configuration, the valve member distal end 125 extends from terminal end 120 toward but not into the shoulder portion 130 (i.e., the terminal end does not extend past the location, denoted by dashed line 126, in which the neck portion 110 begins to curve in transition to the shoulder portion). Alternatively, distal end 125 of valve member 115 may extend to small distance (e.g., ½″) away from core 140 so that valve member can be free to close during inflation and to self-reverse during deflation. Device 100 further includes a pneumatic valve 135, which may be of the self-inflating variety, in fluid communication with the main body 105. Valve 135 allows a user of device 100 to “fine tune” the inflation pressure in main body 105 once valve me tuber 115 has been sealed.

As best illustrated in FIG. 2, air can be blown into the neck portion 110 and valve member 115 by positioning the user's mouth a few inches (e.g., 6-10 inches) from the neck portion to promote ambient air entrainment under the Bernoulli Principle through the valve member until the mattress is suitably inflated. As the device inflates, mounting back pressure against the valve member distal end 125 promotes closure of the valve member 115, such that valve member functions as a check valve allowing flow from terminal end 120 to distal end 125.

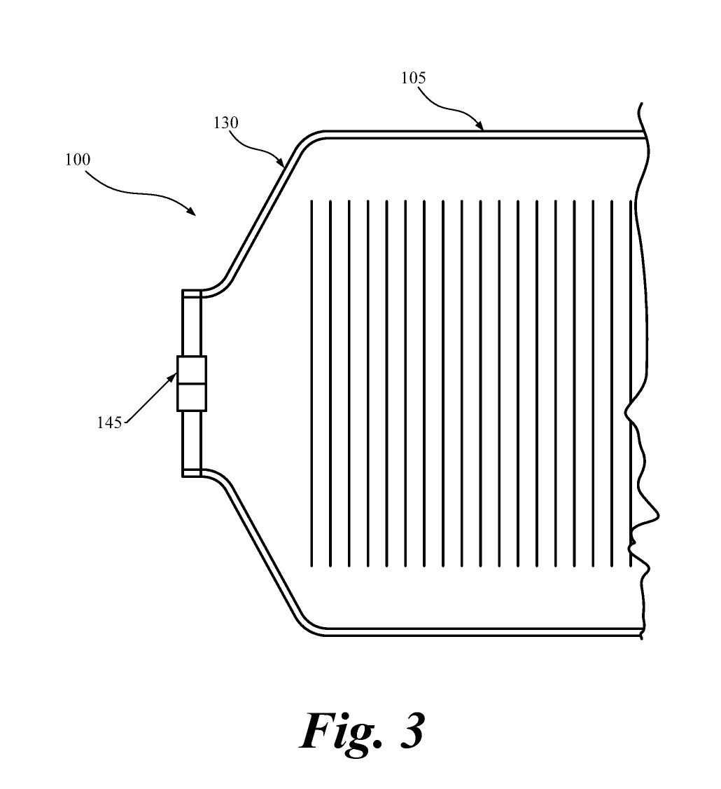

As illustrated in FIG. 3, once the device 100 is suitably inflated, the user can roll the neck portion 110 and a sealing buckle 145 toward shoulder portion 130 and fasten the buckle in place, thereby sealing off the neck portion to prevent air from escaping the device.

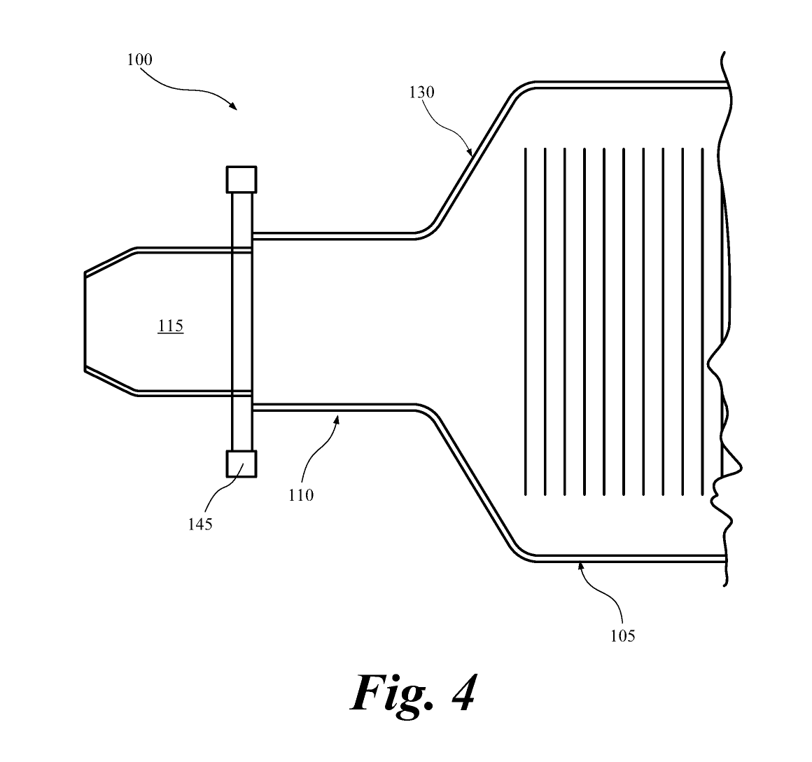

As best illustrated in FIG. 4, the valve member 115 further has a deflation configuration in which the valve member distal end 125 is disposed outside of the neck portion 110 in a direction opposite to that of the inflation configuration. To achieve the deflation configuration, the buckle 145 is unfastened, and the device 100 slightly compressed until the valve member terminal end 120 is forced outside of neck portion 110 and air can escape freely into the ambient environment external to the device. Once device 100 is suitably deflated, valve member 115 can be pushed into the neck portion 110, the buckle 145 fastened, and the device is ready to be stored.

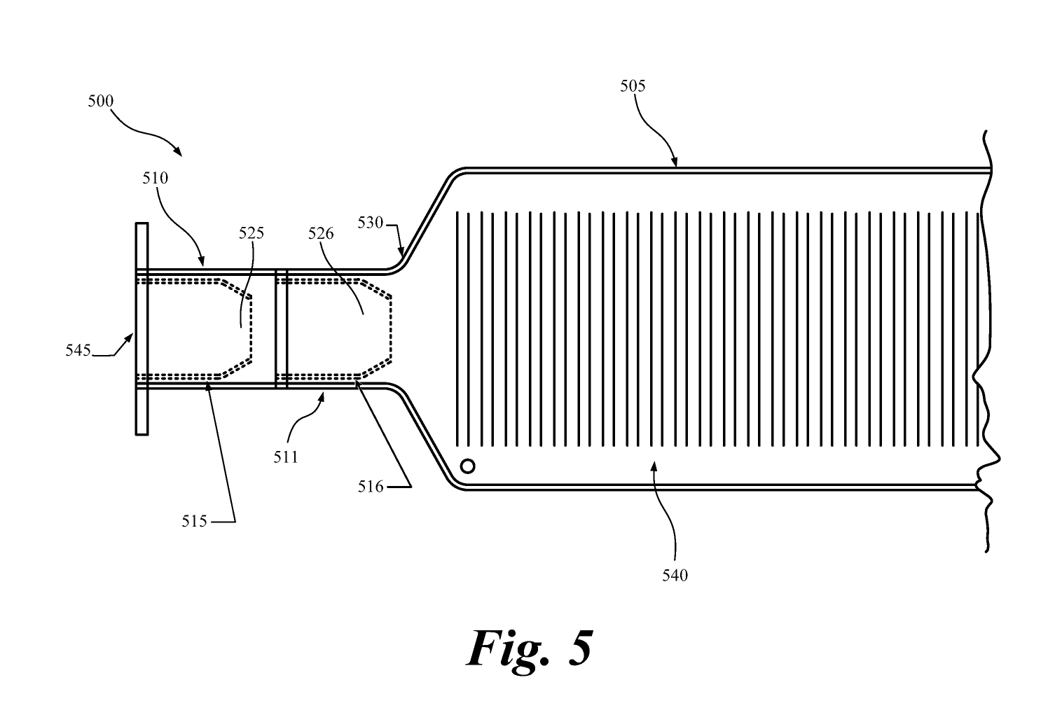

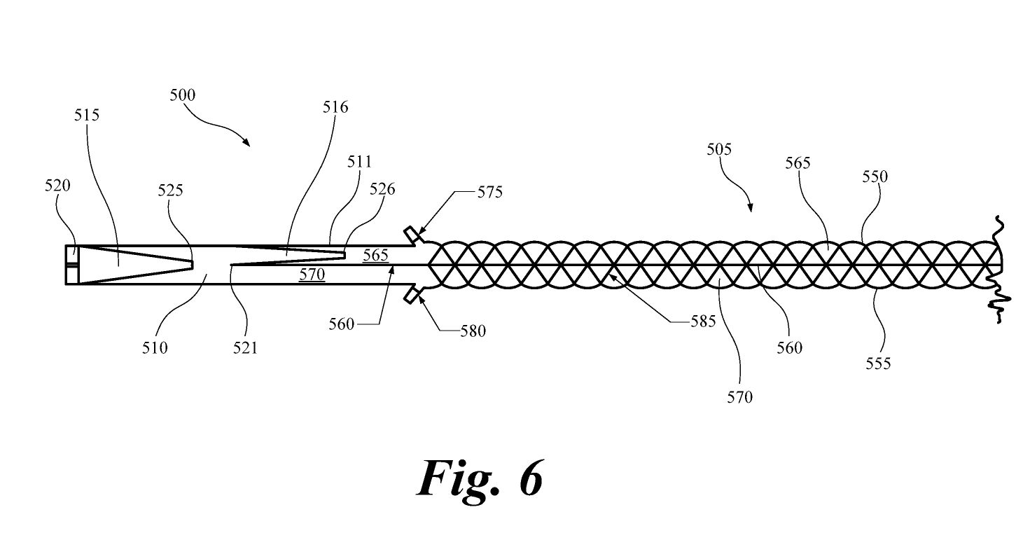

FIGS. 5-8 illustrate alternative embodiments including dual-chambers hut otherwise incorporating all principles and configurations described above herein. The embodiment shown in FIGS. 5-6 uses one high-volume film valve to inflate both chambers taking advantage of the Bernoulli Principle to multiply the air intake and then a second inboard high-volume film valve to inflate a second chamber. The chambers are separated by an air-impermeable center film layer and sealed to the outside and from one another when a roll down closure of the neck portion is made. The user can then selectively adjust the upper and lower chambers for greater comfort and thermal performance using an auxiliary valve for each chamber. Additionally the discrete dual chambers insure that the mattress will remain inflated if one of the chambers is punctured. To speedily deflate the mattress, the user simply unrolls the closure and the trapped air in the mattress automatically reverses both valves for deflation.

Specifically, and referring to FIGS. 5-6, an inflatable cushioning. device 500 includes an inflatable main body 505 having first and second generally opposing internal surfaces 550, 555 and a core 540. An air-impermeable film layer 560 is coupled to and disposed within the main body 505. A first chamber 565 is formed by the film layer 560 and first internal surface 550. A second chamber 570 is formed by the film layer 560 and second internal surface 555. The second chamber 570 is, thusly, pneumatically separated from the first chamber 565 by the film layer 560. Device 500 may also include a sealing buckle 545.

A primary neck portion 510 is pneumatically coupled to the first and second chambers 565, 570. A secondary neck portion 511 is pneumatically coupled to the first chamber 565. Device 500 further includes a shoulder portion 530 serving as a transition zone between main body 505 and the neck portions 510, 511.

A primary valve member 515 includes terminal and distal ends 520, 525. The primary valve member terminal end 520 is attached to the primary neck portion 510. A secondary valve member 516 likewise has terminal and distal ends 521, 526. The secondary valve member terminal end 521 is attached to the secondary neck portion 511. In an embodiment, the width of the valve members 515, 516 is tapered from the terminal ends 520, 521 to the distal ends 525, 526, such that the distal end is less wide than the terminal end, thereby promoting automatic closing of the valve members once the device 500 is fully or near-fully inflated.

In a manner similar to that discussed above with reference to valve member 115, the primary valve member 515 has an inflation configuration in which the primary valve member distal end 525 is disposed inside of the primary neck portion 510. The primary valve member 515 has a deflation configuration in which the primary valve member distal end 525 is disposed outside of the primary neck portion 510 in a direction opposite to that of the inflation configuration.

Similarly the secondary valve member 516 has an inflation configuration in which the secondary valve member distal end 526 is disposed inside of the secondary neck portion 511. The secondary valve member 516 has a deflation configuration in which the secondary valve member distal end 526 is disposed inside of the primary neck portion 510, in a direction opposite to that of the inflation configuration, and outside of the secondary neck portion 511.

When the primary and secondary valve members 515, 516 are in the inflation configuration, the primary and secondary valve member distal ends 525, 526 extend toward but not into the shoulder portion 530. Device 500 further includes pneumatic valves 575, 580, which may be of the self-inflating variety, in fluid communication with the first and second chambers 565, 570, respectively. Valves 575, 580 allow a user of device 500 to “fine tune” the inflation pressure in the first and second chambers 565, 570 once valve members 515, 516 have been sealed.

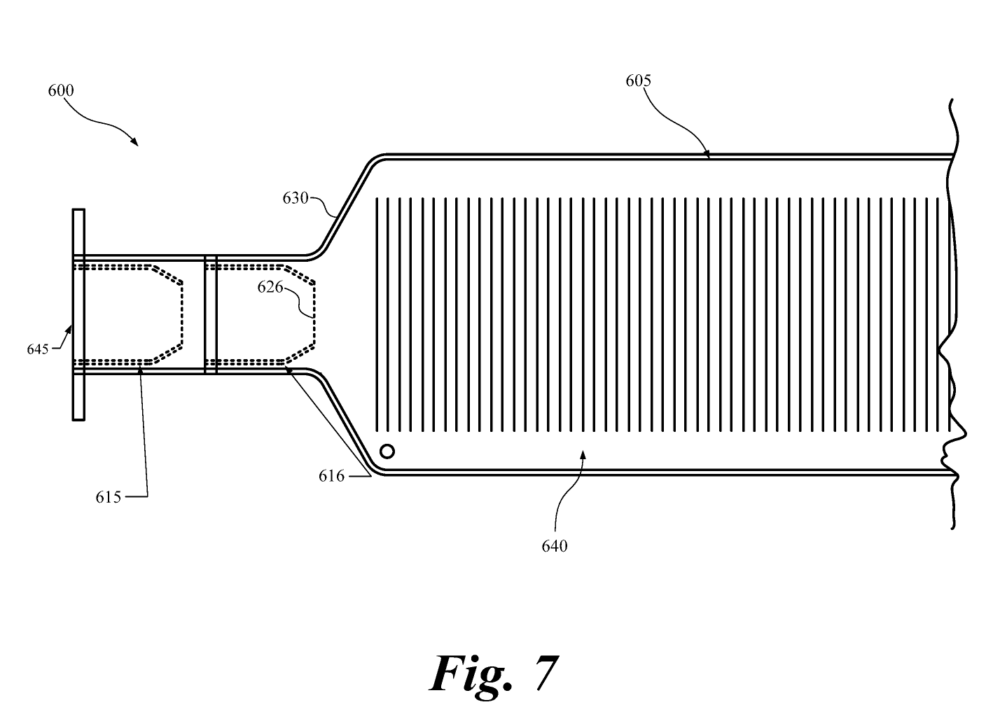

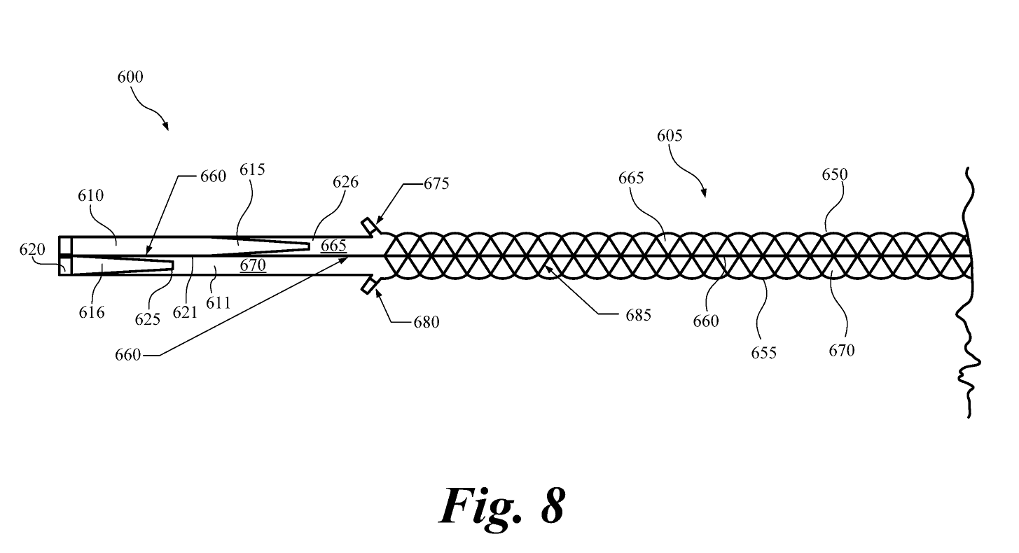

Another version of the improvement described above and in FIGS. 7-8 shows the air impermeable center film layer running all the way out to the end of the roll down closure. In this version the upper and lower chambers are selectively inflated separately.

Specifically, and referring to FIGS. 7-8, an inflatable cushioning device 600 includes an inflatable main body 605 having first and second generally opposing internal surfaces 650, 655 and a core 640. An air-impermeable film layer 660 is coupled to and disposed within the main body 605. Unlike the film layer 560 described with reference to FIGS. 5-6, which only partially extends through device 500, film layer 660 extends through the entire length of device 600. A first chamber 665 is formed by the film layer 660 and first internal surface 650. A second chamber 670 is formed by the film layer 660 and second internal surface 655. The second chamber 670 is, thusly, pneumatically sealed from the first chamber 665 by the film layer 660. Device 600 may also include a sealing buckle 645.

A first neck portion 610 is pneumatically coupled to the first chamber 665. A second neck portion 611 is pneumatically coupled to the second chamber 670. Device 600 further includes a shoulder portion 630 serving as a transition zone between main body 605 and the neck portions 610, 611.

A first valve member 615 includes terminal and distal ends 620, 625. The first valve member terminal end 620 is attached to the first neck portion 610. A second valve member 616 likewise has terminal and distal ends 621, 626. The second valve member terminal end 621 is attached to the second neck portion 611. In an embodiment, the width of the valve members 615, 616 is tapered from the terminal ends 620, 621 to the distal ends 625, 626, such that the distal end is less wide than the terminal end, thereby promoting automatic closing of the valve members once the device 600 is fully or near-fully inflated.

In a manner similar to that discussed above with reference to valve member 115, the first valve member 615 has an inflation configuration in which the first valve member distal end 625 is disposed inside of the first neck portion 610. The first valve member 615 has a deflation configuration in which the first valve member distal end 625 is disposed outside of the first neck portion 610 in a direction opposite to that of the inflation configuration.

Similarly, the second valve member 616 has an inflation configuration in which the second valve member distal end 626 is disposed inside of the second neck portion 611. The second valve member 616 has a deflation configuration in which the second valve member distal end 626 is disposed outside of the second neck portion 611 in a direction opposite to that of the inflation configuration.

When the first and second valve members 615, 616 are in the inflation configuration, the first and second valve member distal ends 625, 626 extend toward but not into the shoulder portion 630. Device 600 further includes pneumatic valves 675, 680, which may be of the self-inflating variety, in fluid communication with the first and second chambers 665, 670, respectively. Valves 675, 680 allow a user of device 600 to “fine tune” the inflation pressure in the first and second chambers 665, 670 once valve members 615, 616 have been sealed.

From the foregoing, it will be appreciated that specific embodiments of the invention have been described herein for purposes of illustration, but that various modifications may be made without deviating from the spirit and scope of the invention. Accordingly, the invention is not limited except as by the appended claims.

What is claimed is:

1. An inflatable cushioning device, comprising:
an inflatable main body;
a neck portion coupled to the main body; and
a valve member having terminal and distal ends, the terminal end being coupled to the neck portion, the valve member having an inflation configuration in which the valve member distal end is disposed inside of the neck portion, and the valve member having a deflation configuration in which the valve member distal end is disposed outside of the neck portion.

2. The device of claim 1, further comprising a shoulder portion coupled to the main body and the neck portion.

3. The device of claim 2, wherein the valve member distal end, when the valve member is in the inflation configuration, extends toward but not into the shoulder portion.

4. The device of claim 1, wherein the width of the valve member is tapered from the terminal end to the distal end.

5. The device of claim 1, further comprising a pneumatic valve in fluid communication with the main body.

6. The device of claim 5, wherein the pneumatic valve is a self-inflating valve.

7. An inflatable cushioning device, comprising:
an inflatable main body having first and second generally opposing internal surfaces;
an air-impermeable film layer coupled to and disposed within the main body, whereby a first chamber is formed by the film layer and first internal surface, a second chamber is formed by the film layer and second internal surface, the second chamber being pneumatically separated from the first chamber by the film layer;
a primary neck portion pneumatically coupled to the first and second chambers;
a secondary neck portion pneumatically coupled to the first chamber;
a primary valve member having terminal and distal ends, the primary valve member terminal end being coupled to the primary neck portion, the primary valve member having an inflation configuration in which the primary valve member distal end is disposed inside of the primary neck portion, and the primary valve member having a deflation configuration in which the primary valve member distal end is disposed outside of the primary neck portion; and
a secondary valve member having terminal and distal ends, the secondary valve member terminal end being coupled to the secondary neck portion, the secondary valve member having an inflation configuration in which the secondary valve member distal end is disposed inside of the secondary neck portion, and the secondary valve member having a deflation configuration in which the secondary valve member distal end is disposed inside of the primary neck portion.

8. The device of claim 7, further comprising a shoulder portion coupled to the main body and the neck portions.

9. The device of claim 8, wherein the primary and secondary valve member distal ends, when the primary and secondary valve members are in the inflation configuration, extend toward but not into the shoulder portion.

10. The device of claim 7, wherein the width of the primary valve member is tapered from the primary valve member terminal end to the primary valve member distal end.

11. The device of claim 7, wherein the width of the secondary valve member is tapered from the secondary valve member terminal end to the secondary valve member distal end.

12, The device of claim 7, further comprising first and second pneumatic valves in fluid communication with the first and second chambers, respectively.

13. An inflatable cushioning device, comprising:
an inflatable main body having first and second generally opposing internal surfaces;
an air-impermeable film layer coupled to and disposed within the main body, whereby a first chamber is formed by the film layer and first internal surface, a second chamber is formed by the film layer and second internal surface, the second chamber being pneumatically sealed from the first chamber by the film layer;
a first neck portion pneumatically coupled to the first chamber;
a second neck portion pneumatically coupled to the second chamber;
a first valve member having terminal and distal ends, the first valve member terminal end being coupled to the first neck portion, the first valve member having an inflation configuration in which the first valve member distal end is disposed inside of the first neck portion, and the first valve member having a deflation configuration in which the first valve member distal end is disposed outside of the first neck portion; and
a second valve member having terminal and distal ends, the second valve member terminal end being coupled to the second neck portion, the second valve member having an inflation configuration in which the second valve member distal end is disposed inside of the second neck portion, and the second valve member having a deflation configuration in which the second valve member distal end is disposed outside of the second neck portion.

14. The device of claim 13, further comprising a shoulder portion coupled to the main body and the neck portions.

15. The device of claim 14, wherein the first and second valve member distal ends, when the first and second valve members are in the inflation configuration, extend toward but not into the shoulder portion.

16. The device of claim 13, wherein the width of the first valve member is tapered from the first valve member terminal end to the first valve member distal end.

17. The device of claim 13, wherein the width of the second valve member is tapered from the second valve member terminal end to the second valve member distal end.

18. The device of claim 13, further comprising first and second pneumatic valves in fluid communication with the first and second chambers, respectively.
